(19) United States
(12) Patent Application Publication
(10) Pub. No.: US 2016/0033296 A1
(43) Pub. Date: Feb. 4, 2016

(54) ELECTRONIC MAP WITH DIRECTIONAL RENDERING METHOD AND SYSTEM

(71) Applicant: ZB Technology Co., Ltd., Taipei City (TW)

(72) Inventor: Brian YEH, Taipei City (TW)

(21) Appl. No.: 14/572,568

(22) Filed: Dec. 16, 2014

(30) Foreign Application Priority Data
Aug. 1, 2014 (TW) 103126525

(51) Int. Cl. G01C 21/36; G01C 21/34

(52) U.S. Cl. CPC G01C 21/3644; G01C 21/3476

(57) ABSTRACT

In an electronic map rendering method and system of the present invention, the electronic map rendering system includes an electronic map database, a planning module, and a display module. The electronic map database includes a plurality of street data, and position information of a plurality of service providers adjacent to a plurality of streets. After setting a starting position and a destination position or through detection of the traveling direction, the system is able to plan a driving route. After which, position information is then obtained of a plurality of service providers in the electronic map database closest to the driving route.

### BACKGROUND OF THE INVENTION

(a) Field of the Invention

The present invention relates to a rendering method and system, and more particularly to an electronic map rendering method and system.

(b) Description of the Prior Art

Following the prevalence of the automobile industry, means of transportation such as automobiles, and the like, have become one of the most important inventions in the progress of modern times. The ability of the automobile to quickly transport people is equivalent to shrinking the distance between people. However, the rapid development of cities has brought about the growing complexity of road connections. Hence, the means to make full use of the roads to quickly reach a destination is an important issue.

The birth of the Global Positioning System (hereinafter referred to as GPS) has brought great convenience for a great number of people, relieving them, as long as they have a GPS navigation system, of the worry about getting lost or other related issues even when entering an unfamiliar geographic area. When using a vehicle GPS navigation device, the user simply enters their starting position and destination position, whereupon the device proceeds to map out a route; or after the mapping out of a route is completed, the user does not follow the mapped out route, then the GPS navigation device proceeds again to map out a route according to data on their current location.

The development of GPS navigation devices has enabled such devices to also provide the navigational directions to various additional service providers (such as gasoline stations, gas filling stations, charging stations, convenience stores, or other physical storefronts able to provide services), which further increases convenience when driving.

However, as for devices that lack navigational functions, such as smart mobile phones that only provide an electronic map as the main service provider, when the user wants to inquire about gasoline stations, the electronic map service is only able to display the locations of all gas stations, causing the entire screen image to be extremely cluttered. At best, such devices can limit the query to gas stations in the vicinity of a certain road, however, they do not provide services that integrate with route plans.

### SUMMARY OF THE INVENTION

The primary objective of an electronic map rendering method and system of the present invention is to indicate on an electronic map only a plurality of service providers on driving routes or navigation directions to avoid the display of service providers not on the driving routes, and thus avoid displaying service providers that the user does not need to know.

A second objective of the electronic map rendering method and system of the present invention lies in the use of numbers or other symbols to indicate the service providers, which are used to guide the user to find the nearest service provider.

Based on the above objectives, the electronic map rendering method and system of the present invention comprises an electronic map database, a planning module, and a display module. The electronic map database primarily comprises a plurality of street data, and position information of a plurality of service providers adjacent to a plurality of streets. After setting a starting position and a destination position, or through detection of the driving direction, the system is able to plan a driving route (primarily from the plurality of streets passed through from the starting position to the destination position) according to the starting position and destination position or direction and based on the street information provided by the map database, as well as obtain position information of the plurality of service providers adjacent to the plurality of streets in the electronic map database based on the plurality of streets on the driving route. The electronic map then only indicates the plurality of service providers on the driving route.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of an electronic map rendering system of the present invention.

FIGS. 2A˜2C are schematic views depicting movement on the electronic map rendering system of the present invention.

FIG. 3 is a flow diagram of the electronic map rendering method of the present invention.

### DETAILED DESCRIPTION OF THE PREFERRED EMBODIMENTS

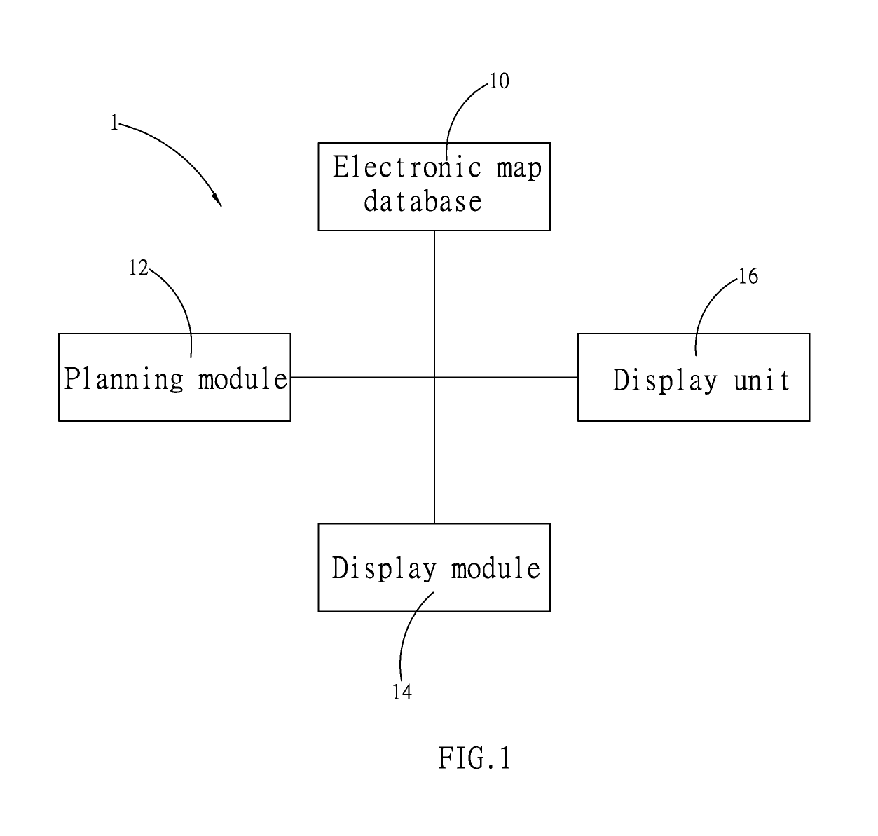

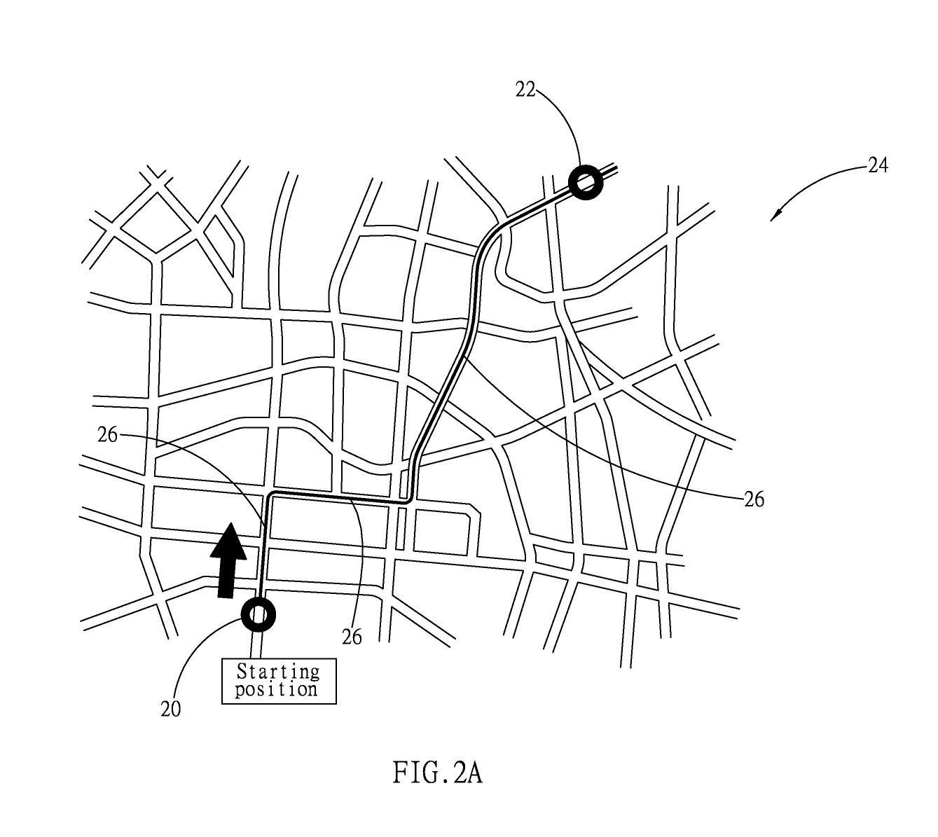

Referring to FIG. 1, which shows a schematic view of an electronic map rendering system of the present invention, wherein an electronic map rendering system 1 of the present invention primarily comprises an electronic map database 10, a planning module 12, and a display module 14. The electronic map database 10 primarily comprises a plurality of street data and position information of a plurality of service providers adjacent to the plurality of streets. After the user sets a starting position and a destination position through a touch display unit 16 or other input means, then the planning module 12 is able to plan a driving route (primarily from the plurality of streets passed through from the starting position to the destination position) according to the starting position and the destination position or direction based on the street data provided by the electronic map database 10. Then the display module 14 obtains position information of a plurality of service providers adjacent to the plurality of streets in the electronic map database 10 according to the plurality of streets on the driving route, and the display unit 16 only indicates on the electronic map the plurality of service providers along the driving route. Wherein the service providers can be gasoline stations, gas filling stations, charging stations, convenience stores, or other physical storefronts able to provide services.

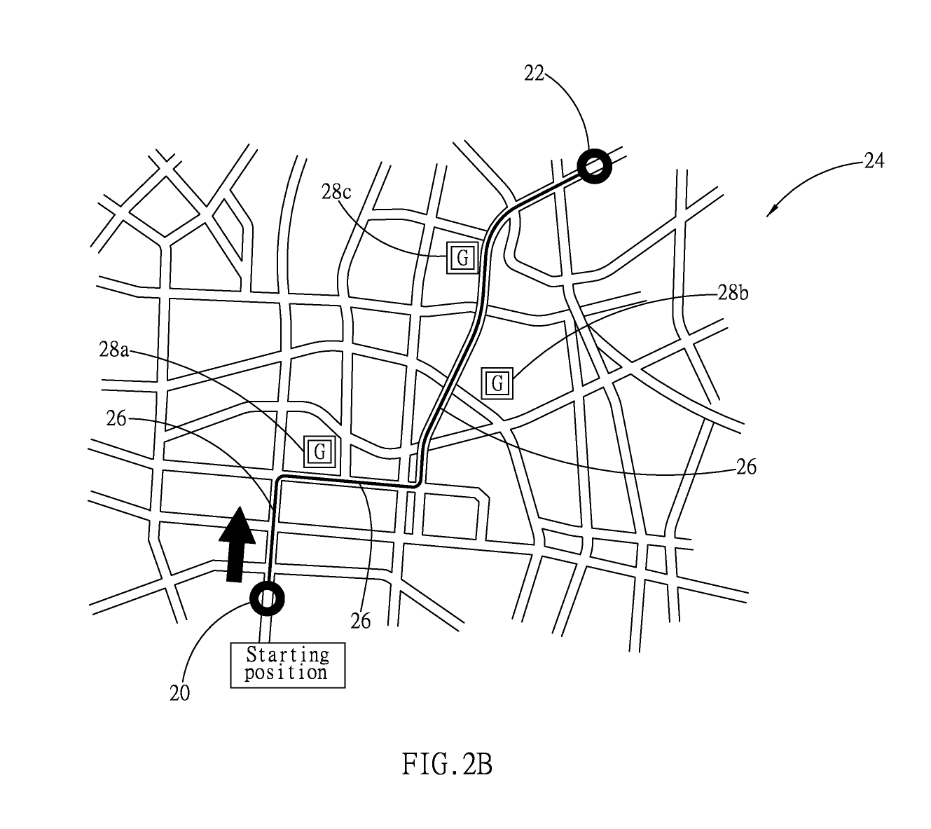

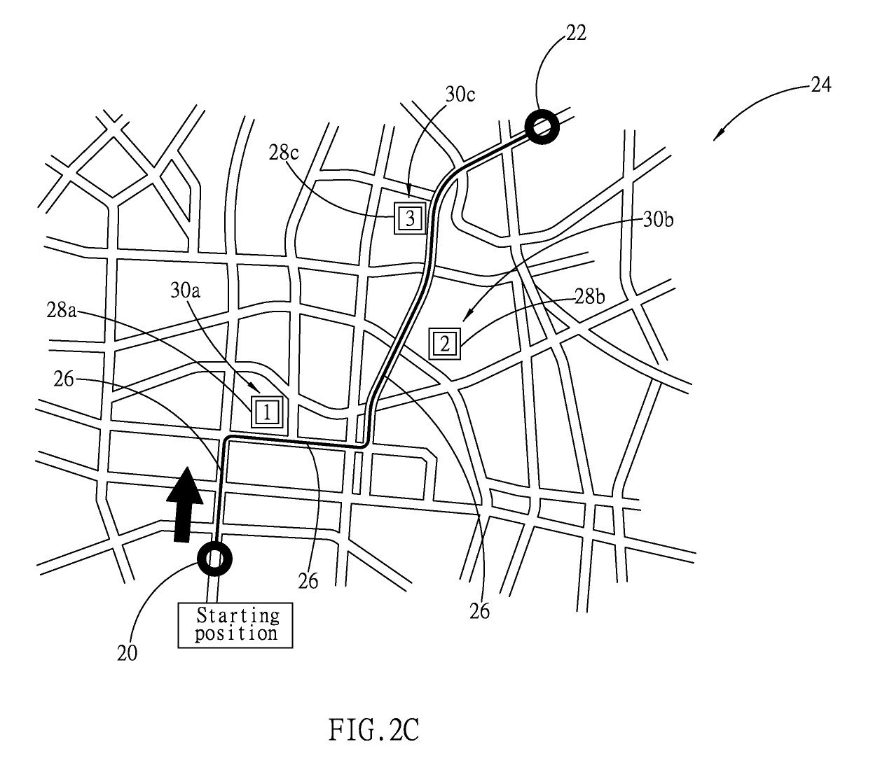

Referring to FIG. 1 and FIGS. 2A˜2C, which show schematic views depicting movement on the electronic map rendering system of the present invention, and as depicted in FIG. 2A, when the user activates the electronic map function, the display unit 16 displays the relevant electronic map based on street data 24 provided by the electronic map database 10. After the user respectively sets a starting position and a destination position or direction through the touch display unit 16 or other input means, the planning module 12 plans a driving route 26 (comprising the plurality of streets passed through from the starting position to destination position) according to a minimum time or minimum distance decision model based on the street data 24 provided by the electronic map database 10 (such as traffic flow on the streets, distance, and so on) and according to the starting position and the destination position or direction.

Referring to FIG. 1 and FIG. 2B, in order to only indicate on the electronic map the plurality of service providers 28a˜28c along the driving route 26, and avoid displaying service providers 28a˜28c not on the driving route 26, as well as avoid displaying service providers 28a˜28c that the user does not need to know about, the display module 14 obtains position information of the plurality of service providers 28a˜28c (such as latitude and longitude) adjacent to a plurality of streets in the electronic map database 10 according to the plurality of streets along the driving route, and on the electronic map only indicate the plurality of service providers 28a˜28c along the driving route 26 based on the position information of the plurality of service providers 28a˜28c. However, there is the possible presence of the service providers 28a˜28c at the same position but on different sides of the same street. Hence, there is still the need for a decision on whether to display the service providers 28a˜28c according to whether the service providers 28a˜28c are on the forward side of the traveling vehicle or on the reverse traffic side. More specifically, if a vehicle is traveling along the right-hand side of the road, then from a starting position 20 toward a destination position 22 the right-hand side of the road in the traveling direction can be defined as the forward side. Accordingly, the display module 14 obtains position information of the plurality of service providers 28a˜28c adjacent to the plurality of streets according to the plurality of streets on the forward side of the driving route 26.

For example, only if a vehicle can drive directly into the service providers from the original driving route can the service providers be said to be adjacent to the street. Nevertheless, if there is a linear distance to the service provider adjacent to the street, but requires the vehicle to pass through a small roadway before being able to enter the service provider, then the service provider can also be said to be adjacent to the street. However, such a service provider will be placed lower in order of priority.

Referring to FIG. 1 and FIG. 2C, according to distance information of the plurality of service providers 28a˜28c from the starting position 20 or the destination position 22 and based on position information of a plurality of service providers 28a˜28c, the display module 14 only indicates on the electronic map the plurality of service providers 28a˜28c on the driving route 26 and sequential markers 30a˜30c corresponding to the distance information. If the sequential markers 30a˜30c are numbers, then the larger the number of the sequential marker the further away the service providers 28a˜28c are from the starting position 20 or the destination position 22. For example, because the service provider 28a is nearest to the starting position 20, thus, the number of the corresponding sequential marker 30a is 1, and the service provider 28c is furthest from the starting position 20, thus, the number of the corresponding sequential marker 30c is 3.

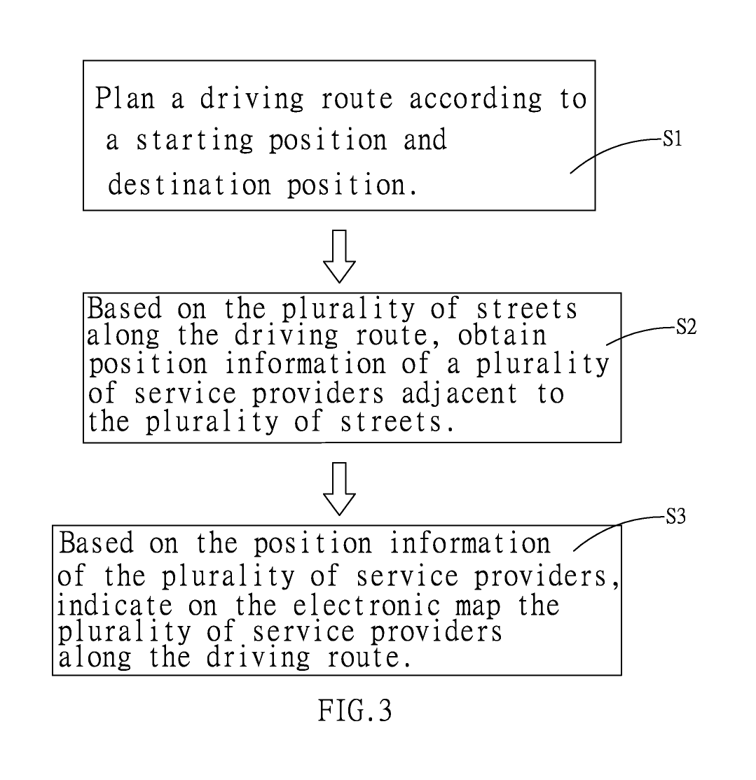

Referring to FIG. 3, which shows a flow diagram of the electronic map rendering method of the present invention, and as depicted in FIG. 3, a first step S1 in the electronic map rendering method of the present invention is planning a driving route according to the starting position and the destination position based on street data provided by the electronic map database. A next step S2 is obtaining position information of a plurality of service providers adjacent to the plurality of streets in the electronic map database based on the plurality of streets along the driving route. A final step S3 is indicating the plurality of service providers along the driving route on the electronic map based on position information of the plurality of service providers.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An electronic map rendering method, comprising steps of:
a) planning a driving route according to a starting position and a destination position or direction based on street data provided by an electronic map database, the driving route comprises a plurality of streets passed through from the starting position to the destination position;
b) obtaining position information of a plurality of service providers adjacent to the plurality of streets along the driving route in the electronic map database; and
c) based on position information of the the plurality of service providers, only indicating on an electronic map the plurality of service providers on the driving route and avoid displaying service providers not on the driving route.

2. The electronic map rendering method as described in claim 1, wherein the service providers are gasoline stations, gas filling stations, charging stations, convenience stores, or other physical storefronts able to provide services.

3. The electronic map rendering method as described in claim 1, wherein position information of the plurality of service providers adjacent to the plurality of streets is obtained according to the plurality of streets on a forward side along the driving route.

4. The electronic map rendering method as described in claim 1, wherein, according to distance information of the plurality of service providers from the starting position or the destination position, and based on position information of the plurality of service providers, only the plurality of service providers on the driving route and sequential markers corresponding to the distance information are indicated on the electronic map.

5. The electronic map rendering method as described in claim 4, wherein the sequential markers are numbers, and the larger the number of the sequential marker the further away the corresponding service provider is from the starting position or the destination position.

6. An electronic map rendering system, including:
an electronic map database, primarily comprising a plurality of street data, and position information of a plurality of service providers adjacent to a plurality of streets;
a planning module, the planning module plans a driving route according to a starting position and a destination position based the on the street information provided by the electronic map database, the driving route including the plurality of streets passed through from the starting position to the destination position;
a display module, wherein the position information of the plurality of service providers adjacent to the plurality of streets along the driving route in the electronic map database is obtained, and the display module only indicates on the electronic map the plurality of service providers on the driving route and avoid displaying service providers not on the driving route.

7. The electronic map rendering system as described in claim 6, wherein the service providers are gasoline stations, gas filling stations, charging stations, convenience stores, or other physical storefronts able to provide services.

8. The electronic map rendering system as described in claim 6, wherein the position information of the plurality of service providers adjacent to the plurality of streets is obtained according to the plurality of streets on a forward side along the driving route.

9. The electronic map rendering system as described in claim 6, wherein, according to distance information of the plurality of service providers from the starting position or the destination position, and based on the position information of the plurality of service providers, only the plurality of service providers on the driving route and sequential markers corresponding to the distance information are indicated on the electronic map.

10. The electronic map rendering system as described in claim 9, wherein the sequential markers are numbers, and the larger the number of the sequential marker the further away the corresponding service provider is from a user.
